(19) United States
(12) Patent Application Publication
(10) Pub. No.: US 2019/0235802 A1
(43) Pub. Date: Aug. 1, 2019

(54) Printing System, Printer, Information Processor, and Terminal Device

(71) Applicant: Konica Minolta, Inc., Tokyo (JP)

(72) Inventors: Atsushi TAMURA, Amagasaki-shi (JP); Yuji OKAMOTO, Amagasaki-shi (JP); Hidetaka IWAI, Itami-shi (JP); Takehisa YAMAGUCHI, Ikoma-shi (JP); Nobuhiro MISHIMA, Osaka (JP); Katsuyuki SUGITA, Osaka (JP)

(73) Assignee: Konica Minolta, Inc., Tokyo (JP)

(21) Appl. No.: 16/260,185

(22) Filed: Jan. 29, 2019

(30) Foreign Application Priority Data
Feb. 1, 2018 (JP) 2018-016584

(51) Int. Cl. G06F 3/12

(52) U.S. Cl. CPC G06F 3/1215; G06F 3/1258; G06F 3/1259

(57) ABSTRACT

A printing system includes: a printer; and a terminal device, wherein an inquirer that inquires of the printer a predicted time to be taken for printing a document to be printed is provided in the terminal device, a calculator that calculates a predicted time to be taken for the printer to print the document under each of a plurality of conditions and a responder that responds to the terminal device about the predicted time for each of the conditions are provided in the printer, a presenter that displays the conditions and the predicted time for each of the conditions on a display and an instructor that instructs the printer to print the document under a condition selected from the conditions are also provided in the terminal device, and a printing part that prints the document under the condition selected from the conditions is also provided in the printer.

The entire disclosure of Japanese patent Application No. 2018-016584, filed on Feb. 1, 2018, is incorporated herein by reference in its entirety.

### BACKGROUND

### Technological Field

The present invention relates to a technique for printing a document.

### Description of the Related Art

In recent years, image forming apparatuses in which functions such as copying, network printing, a facsimile, scanning, and a file server are aggregated have been common. Such image forming apparatuses are called, for example, “multi function machines” or “multi function peripherals (MFPs)”.

An image forming apparatus is shared by a plurality of users at a company or a government office. These users can cause the image forming apparatus to perform printing by directly operating the image forming apparatus, and can cause the image forming apparatus to perform printing by directly operating the image forming apparatus remotely via a communication line with a terminal device.

The user can also designate various conditions as a condition for printing a document. A resolution can be designated as one of the conditions. The higher the designated resolution is, the longer time it takes for printing.

The technique as follows has thus been proposed as a technique for shortening a time taken for printing.

Received PDL data is analyzed, and a display list in a unit to be rendered is generated. It is then determined whether the display list is a character/line drawing or a halftone image containing a photographic image. When the display list is determined to be the character/line drawing, the display list is resized according to the resolution of a printer engine, and rendered with each color component at an eight-bit precision (integer). In addition, when the display list is determined to be the halftone image containing a photographic image, the display list is resized according to the resolution of the printer engine, and rendered with each color component at ten-bit precision (eight integers+two bits after the decimal point).

A user may want to cause an image forming apparatus to print a document as soon as possible to acquire the printed matter. This is, for example, when a document necessary for a business trip or a meeting is completed just before the departure for the business trip or the start of the meeting.

A conventional technique as described in JP 2007-182060 A can shorten a time until the printed matter is acquired. In order to acquire the printed matter as quickly as possible, however, a change of a condition, for example, lowering of a resolution is desirable.

Unfortunately, when a condition is changed, the printed matter may be in a finished state that the user does not intend.

### SUMMARY

In light of such a problem, an object of the invention is to provide a printed matter in a state desired by a user more reliably than before when the user is in a hurry.

To achieve the abovementioned object, according to an aspect of the present invention, a printing system reflecting one aspect of the present invention comprises a printer; and a terminal device, wherein an inquirer that inquires of the printer a predicted time to be taken for printing a document to be printed is provided in the terminal device, a calculator that calculates a predicted time to be taken for the printer to print the document under each of a plurality of conditions and a responder that responds to the terminal device about the predicted time for each of the plurality of conditions are provided in the printer, a presenter that displays the plurality of conditions and the predicted time for each of the plurality of conditions on a display and an instructor that instructs the printer to print the document under a condition selected from the plurality of conditions are also provided in the terminal device, and a printing part that prints the document under the condition selected from the plurality of conditions is also provided in the printer.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 illustrates an example of the overall configuration of a printing system;

FIG. 2 illustrates an example of the hardware configuration of an image forming apparatus;

FIG. 3 illustrates an example of the hardware configuration of a terminal device;

FIG. 4 illustrates an example of the functional configuration of each of the image forming apparatus and the terminal device;

FIG. 5 illustrates an example of a document;

FIG. 6 illustrates an example of a condition input screen;

FIG. 7 illustrates an example of a unit required time table;

FIG. 8 illustrates an example of job data;

FIG. 9 illustrates an example of result data;

FIG. 10 illustrates an example of a condition selection screen;

FIG. 11 illustrates an example of response data;

FIGS. 12A to 12D illustrate examples of messages displayed in a message area;

FIG. 13 is a flowchart illustrating an example of the overall processing flow of the image forming apparatus;

FIG. 14 is a flowchart illustrating an example of the overall processing flow of the terminal device;

FIG. 15 illustrates a variation of the overall configuration of the image forming apparatus;

FIG. 16 illustrates an example of the condition selection screen;

FIGS. 17A and 17B illustrate variations of the condition selection screen;

FIG. 18 illustrates an example of a threshold designation screen; and

FIG. 19 illustrates a variation of the condition selection screen.

### DETAILED DESCRIPTION OF EMBODIMENTS

Hereinafter, one or more embodiments of the present invention will be described with reference to the drawings. However, the scope of the invention is not limited to the disclosed embodiments.

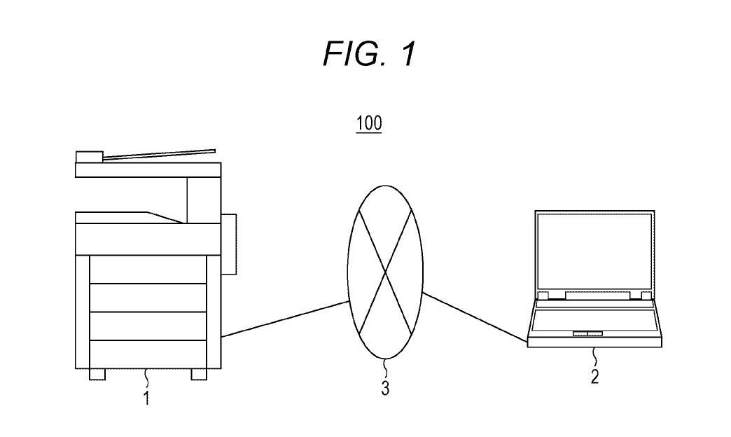

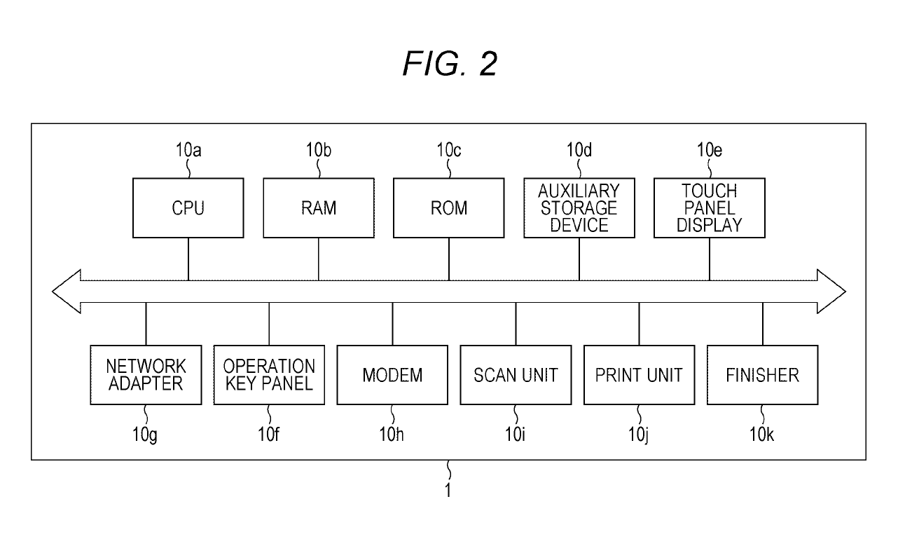

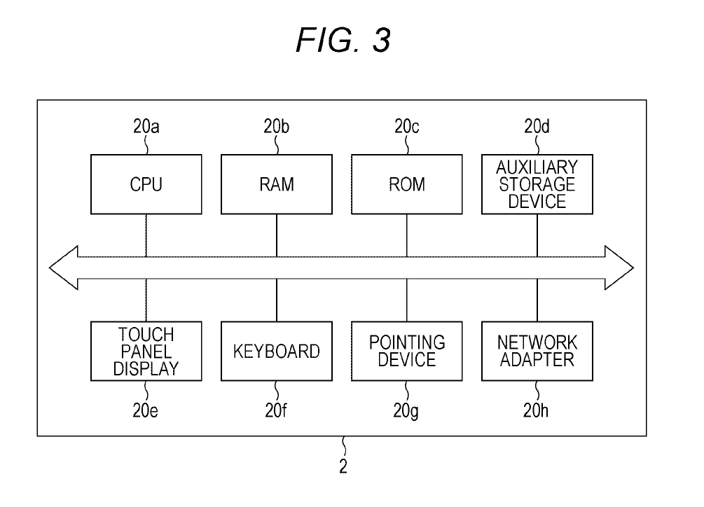

FIG. 1 illustrates an example of the overall configuration of a printing system 100. FIG. 2 illustrates an example of the hardware configuration of an image forming apparatus 1. FIG. 3 illustrates an example of the hardware configuration of a terminal device 2.

The printing system 100 illustrated in FIG. 1 is a system for printing a document on paper, and includes the image forming apparatus 1, the terminal device 2, and a communication line 3.

The image forming apparatus 1 and the terminal device 2 can communicate via the communication line 3. For example, the Internet, an Ethernet (registered trademark) line, a wireless local area network (LAN) line, a public line, or a leased line is used as the communication line 3.

The image forming apparatus 1 is a device that aggregates functions such as copying, PC printing, a facsimile, scanning, and a box. In general, the image forming apparatus 1 may be called, for example, “multi function machines” or “multi function peripherals (MFP)”.

The PC print function is a function of printing an image on paper based on image data received from the terminal device 2. The PC print may be called, for example, “network printing” or “network print”.

The box function is a function with which each user stores and manages, for example, image data using his/her own storage area. The storage area is called, for example, a “box” or a “personal box”, and given to each user. The box can be provided for each group, and members of a group can share the box. The box corresponds to a “folder” or a “directory” in a personal computer.

As illustrated in FIG. 2, the image forming apparatus 1 includes a central processing unit (CPU) 10a, a random access memory (RAM) 10b, a read only memory (ROM) 10c, an auxiliary storage device 10d, a touch panel display 10e, an operation key panel 10f, a network adapter 10g, a modem 10h, a scan unit 10i, a print unit 10j, and a finisher 10k.

The touch panel display 10e displays, for example, a screen showing a message to a user, a screen for the user to input a command or information, and a screen showing a result of processing executed by the CPU 10a. The touch panel display 10e also transmits a signal indicating a touched position to the CPU 10a.

The operation key panel 10f is a so-called hardware keyboard, and includes numeric keys, a start key, a stop key, and function keys.

The network adapter 10g communicates with, for example, the terminal device 2 through a protocol such as Transmission Control Protocol/Internet Protocol (TCP/IP). For example, a network interface card (NIC) or a wireless LAN adapter is used as the network adapter 10g.

The modem 10h exchanges image data with a facsimile terminal through a protocol such as G3.

The scan unit 10i reads an image drawn on a sheet set on platen glass to generate image data.

In addition to the image read by the scan unit 10i, the print unit 10j prints an image received from another device by the network adapter 10g or the modem 10h on paper.

The finisher 10k performs post-processing on the printed matter obtained by the print unit 10j as necessary. The post-processing includes stapling processing, punching processing, or folding processing.

A program for implementing each of the above-described functions such as copying is stored in the ROM 10c or the auxiliary storage device 10d. A print job program 10P is also stored. The print job program 10P is a program for executing a print job.

These programs are loaded into the RAM 10b as necessary, and executed by the CPU 10. For example, a hard disk or a solid state drive (SSD) is used as the auxiliary storage device 10d.

The terminal device 2 is a client of the image forming apparatus 1. The user can remotely use the function of the image forming apparatus 1 through the terminal device 2. For example, a personal computer, a smartphone, or a tablet computer is used as the terminal device 2. An example in which a personal computer is used as the terminal device 2 will now be described.

As illustrated in FIG. 3, the terminal device 2 includes a CPU 20a, a RAM 20b, a ROM 20c, an auxiliary storage device 20d, a touch panel display 20e, a keyboard 20f, a pointing device 20g8, and a network adapter 20h.

The touch panel display 20e displays, for example, a screen for giving a message to a user, a screen showing a result of processing, or a screen for a user to input instructions. The touch panel display 20e also detects a touched position, and notifies the CPU 20a of the position.

The keyboard 20f and the pointing device 20g are used for the user to input, for example, instructions and conditions.

The network adapter 20h communicates with, for example, the image forming apparatus 1 through a protocol such as TCP/IP. For example, an NIC or a wireless LAN adapter is used as the network adapter 20h.

In addition to an operating system and various applications, a printer driver 20P for the image forming apparatus 1 is stored in the auxiliary storage device 20d. Applications for creating or viewing documents, such as a word processor, a spreadsheet application, and a drawing application, are stored as the applications.

These programs are loaded into the RAM 20b, and executed by the CPU 20a. For example, a hard disk or an SSD is used as the auxiliary storage device 20d.

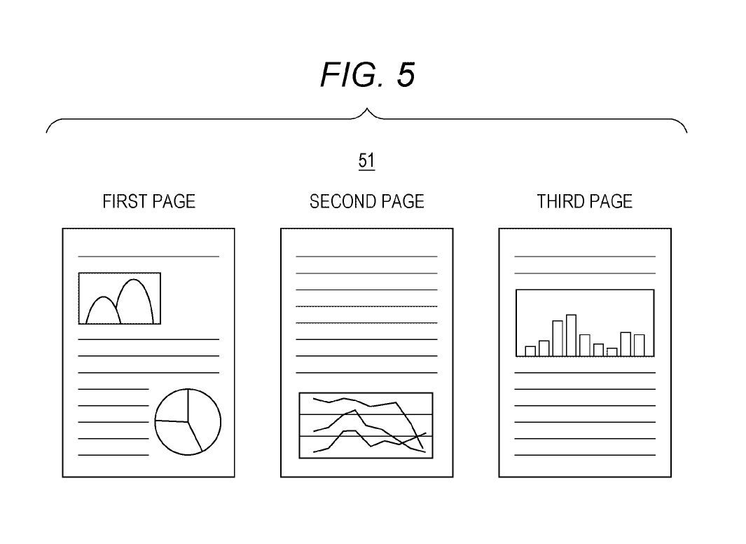

A condition for, for example, printing according to a time the user can wait to acquire a printed matter of a document can be presented to the user by using the print job program 10P and the printer driver 20P. Such a function for presenting a condition for, for example, printing will be referred to as a “condition presenting function”. The mechanism of the condition presenting function will now be described by taking the case of printing a document 5 (see FIG. 5) including one or a plurality of pages as an example. Note that, for simplicity of explanation, each page of each document 5 is defined to have a fixed size, for example, the A4 size.

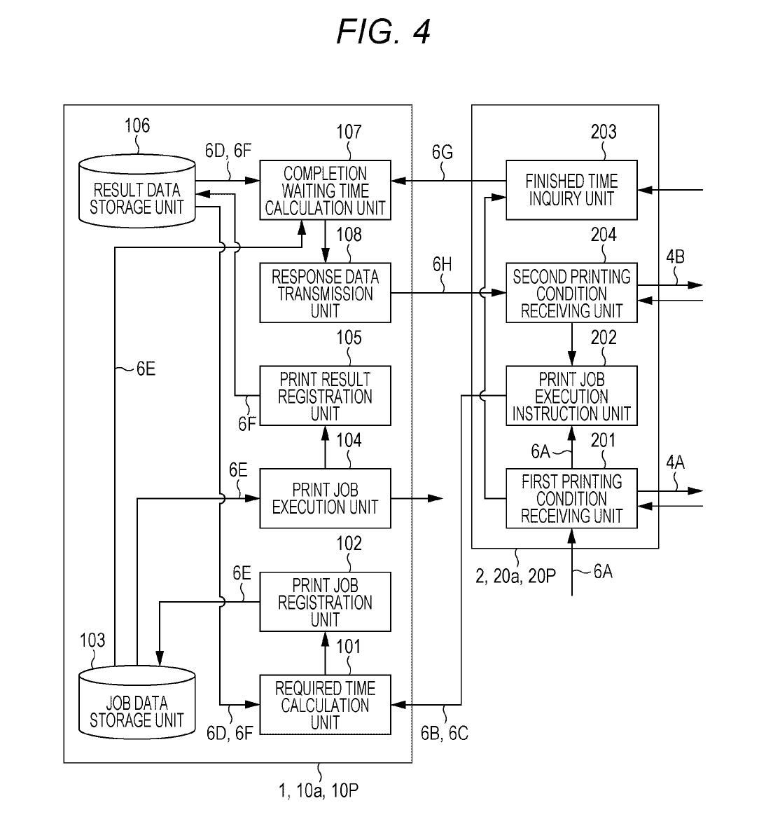

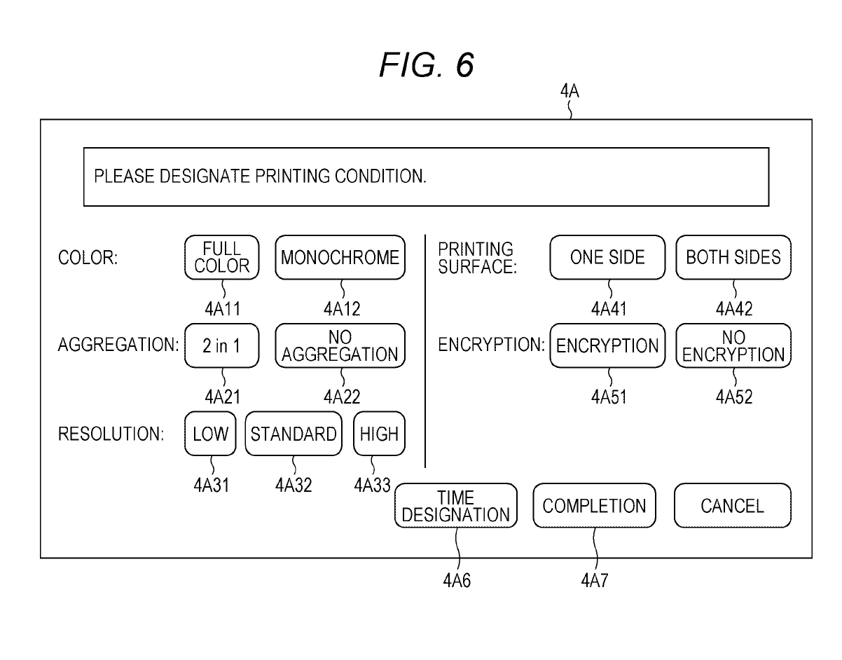

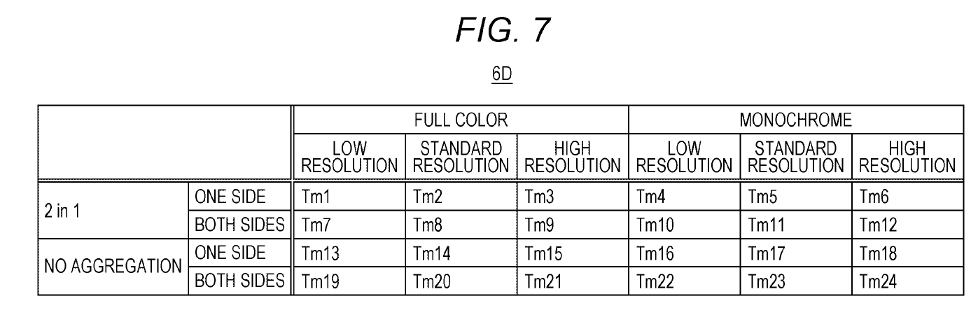

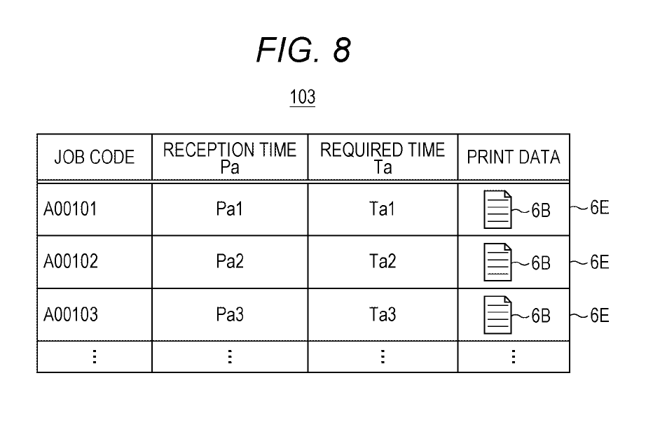

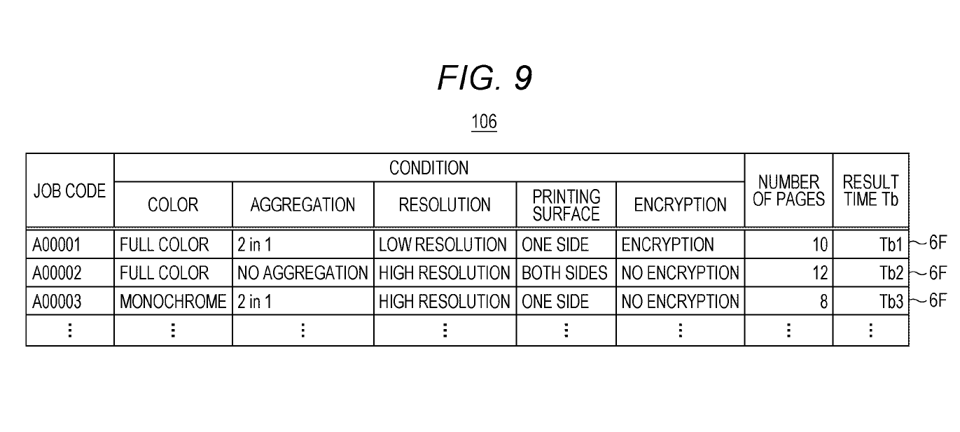

FIG. 4 illustrates an example of the functional configuration of each of the image forming apparatus 1 and the terminal device 2. FIG. 5 illustrates an example of the document 51. FIG. 6 illustrates an example of a condition input screen 4A. FIG. 7 illustrates an example of a unit required time table 6D. FIG. 8 illustrates an example of job data 6E. FIG. 9 illustrates an example of result data 6F.

According to the print job program 10P, functions, such as a required time calculation unit 101, a print job registration unit 102, a job data storage unit 103, a print job execution unit 104, a print result registration unit 105, a result data storage unit 106, a completion waiting time calculation unit 107, and a response data transmission unit 108 each illustrated in FIG. 4, are implemented in the image forming apparatus 1.

According to the printer driver 20P, functions, such as a first printing condition receiving unit 201, a print job execution instruction unit 202, a completion waiting time inquiry unit 203, and a second printing condition receiving unit 204 each illustrated in FIG. 4 are implemented in the terminal device 2.

The user preliminarily prepares a file 6A of the document 5 desired to be printed in the terminal device 2. The file 6A may be created by an application of the terminal device 2, or may be downloaded from a web server on the Internet to the terminal device 2. For example, the file 6A is created as the document 5 of the document 51 including three pages as illustrated in FIG. 5. The file 6A is opened by an application, and then a printing command is input.

The first printing condition receiving unit 201 of the terminal device 2 then executes processing for receiving, for example, conditions for printing the document 5 as follows.

The first printing condition receiving unit 201 display the condition input screen 4A as illustrated in FIG. 6 on the touch panel display 20e.

The user inputs a color condition by clicking a selection button 4A11 when desiring to print the document 5 in full color, and clicking a selection button 4A12 when desiring to print the document 5 in monochrome. Alternatively, the user inputs an aggregation condition by clicking a selection button 4A21 when desiring to print the document 5 with two pages thereof aggregated in one page, and clicking a selection button 4A22 when desiring to print the document 5 with one page thereof in one page. Alternatively, the user inputs a resolution condition by clicking a selection button 4A31 when desiring to print the document 5 at a low resolution (e.g., 300 dpi), clicking a selection button 4A32 when desiring to print the document 5 at a standard resolution (e.g., 600 dpi), and clicking a selection button 4A33 when desiring to print the document 5 at a high resolution (e.g., 1200 dpi).

Alternatively, the user inputs a printing surface condition by clicking a selection button 4A41 when desiring to print the document 5 on only one of two surfaces of paper, and clicking a selection button 4A42 when desiring to print the document 5 on both sides. Alternatively, the user inputs an encryption condition in a printing session by clicking a selection button 4A51 when data of the document 5 is to be encrypted and exchanged in the printing session, and clicking a selection button 4A52 when the data is to be exchanged without being encrypted.

Note that, when using the condition presenting function, the user clicks a time designation button 4A6 without operating the selection buttons 4A11 to 4A52. The processing in this case will be described later.

After inputting the condition for each item, the user clicks a completion button 4A7. The first printing condition receiving unit 201 then receives the condition for each item input to the condition input screen 4A.

The print job execution instruction unit 202 then instructs the image forming apparatus 1 to execute a PC print job as follows.

The print job execution instruction unit 202 generates print data 6B for printing the document 5 according to the condition for each of color, aggregation, resolution, and printing surface received by the first printing condition receiving unit 201. The print data 6B is written in a page description language (PDL) compliant with the image forming apparatus 1.

For example, when the selection buttons 4A12, 4A21, 4A33, and 4A42 are clicked on the condition input screen 4A, that is, when “full color”, “2 in 1”, “high resolution”, and “both sides” are received as the condition for each of color, aggregation, resolution and printing surface, data for printing the document 5 on both sides of paper, with 2 in 1, in full color, and at high resolution is generated as print data 6B.

Furthermore, the print job execution instruction unit 202 generates condition data 6C indicating the condition for each item received by the first printing condition receiving unit 201 and the number of pages of the document 5.

The print job execution instruction unit 202 then instructs the image forming apparatus 1 to execute a PC print job by transmitting the print data 6B and the condition data 6C to the image forming apparatus 1. When the selection button 4A5 is clicked, that is, when “encryption” is received as a condition in a printing session, however, the print job execution instruction unit 202 encrypts and transmits the print data 6B and the condition data 6C. When the selection button 4A52 is clicked, the print job execution instruction unit 202 transmits these data in plaintext.

When the print data 6B and the condition data 6C are received, processing is performed as follows by the print job registration unit 102, the print job execution unit 104, the print result registration unit 105, and the required time calculation unit 101 in the image forming apparatus 1. Note that, when the print data 6B and the condition data 6C are encrypted, the required time calculation unit 101 decrypts these data into plaintext.

The required time calculation unit 101 calculates a required time Ta for the document 5 based on the condition data 6C. The required time Ta is a time predicted to be taken for printing a document using PDL data in the case where the print unit 10j is not performing printing but has already been warmed up.

Consequently, for example, the required time Ta for the document 51 is time taken for printing the document 51 using the print data 6B of the document 51 in the case where the print unit 10j is not printing another document 5. The required time Ta can be referred to as a time taken for printing the document 51 based on the condition data 6C of the document 51.

The required time Ta can be calculated by a known method. For example, the required time Ta may be calculated as follows.

The unit required time table 6D is preliminarily prepared. As illustrated in FIG. 7, an average required time per page for the document 5 is indicated for each combination of conditions of the above-described four items in the unit required time table 6D.

The average required time per page for the document 5 will hereinafter be referred to as a “unit required time Tm”. For example, a unit required time Tm1 is indicated in the unit required time table 6D as the unit required time Tm in the case where the document 5 is printed on one side of paper, with 2 in 1, in full color, and at a low resolution.

Moreover, a combination of the conditions of the four items will be referred to as a “printing condition group”. In the example, the items of color, aggregation, resolution, and printing surface respectively have two, two, three, and two conditions. Therefore, there exist 2×2×3×2 sets, that is, 24 sets of printing condition groups.

The unit required times Tm1 to Tm24 can be determined by causing the print unit 10j to print the document 5 in each printing condition group and measuring the time taken for printing.

For example, the unit required time Tm1 can be determined as follows. The print unit 10j is caused to successively print a plurality of documents 5 on one side of paper, with 2 in 1, in full color, and at a low resolution, and the time taken for printing each document is measured. Then, a value obtained by dividing the total of the times measured for documents 5 by the total number of pages of documents 5 is calculated as the unit required time Tm1.

Note that the unit required time table 6D is required to be stored in, for example, the result data storage unit 106.

The required time calculation unit 101 selects the unit required time Tm corresponding to the printing condition group indicated in the condition data 6C from the unit required times Tm1 to Tm24 indicated in the unit required time table 6D. The product of the selected unit required time Tm and the number of pages indicated in the condition data 6C is then calculated as the required time Ta. For example, when “monochrome”, “2 in 1”, “high resolution”, and “both sides” are indicated as the conditions for the four items in the condition data 6C, and “3” is indicated as the number of pages, the product of unit required time Tm22 and “3” is calculated as the required time Ta.

The print job registration unit 102 issues a unique code as a job code, generates the job data 6E, and causes the job data storage unit 103 to store the job data 6E.

As illustrated in FIG. 8, the issued job code, a reception time point Pa. and the required time Ta calculated by the required time calculation unit 101 are indicated in the job data 6E. The reception time point Pa is the time point when the print data 6B and the condition data 6C are received. Furthermore, the job data 6E includes the print data 6B.

The print job execution unit 104 executes a job by using the print data 6B contained in the job data 6E that is stored in the job data storage unit 103. Specifically, the print job execution unit 104 prints the document 5 on paper using the print data 6B. When a plurality of pieces of job data 6E is stored in the job data storage unit 103, however, the print job execution unit 104 executes the job using the pieces of job data 6E in order from the job data 6E having the earlier reception time point Pa.

Upon completion of the job, the print job execution unit 104 deletes the job data 6E from the job data storage unit 103.

When the print job execution unit 104 finishes executing the job, the print result registration unit 105 generates the result data 6F and causes the result data storage unit 106 to store the result data 6F.

As illustrated in FIG. 9, the job code of the job, the condition and the number of pages indicated in the condition data 6C of the job, and result time Tb are indicated in the result data 6F. The result time Tb is the time taken from the start to the end of execution of the job.

Each time the job is executed, the result data 6F is generated by the print result registration unit 105, and stored in the result data storage unit 106. As a result, the result data 6F is accumulated in the result data storage unit 106.

Note that, instead of selecting the unit required time Tm from the unit required time table 6D, the required time calculation unit 101 can calculate the unit required time Tm based on the result data 6F (see FIG. 9) stored in the result data storage unit 106. The product of the calculated unit required time Tm and the number of pages indicated in the condition data 6C may then be calculated as the required time Ta.

When the print data 6B and the condition data 6C are received, the required time calculation unit 101 reads the result data 6F, whose condition of each of the four items, that is, printing condition group is the same as that indicated in the condition data 6C, from the result data storage unit 106.

For example, when “monochrome”, “2 in 1”, “high resolution”, and “one side” are indicated in the condition data 6C, the required time calculation unit 101 reads the result data 6F indicating the same as those from the result data storage unit 106. When a plurality of pieces of such result data 6F is stored, the required time calculation unit 101 reads all pieces of such result data 6F. Alternatively, the required time calculation unit 101 may read only a predetermined number of (e.g., five) pieces of result data 6F preferentially from the newer result data 6F.

The required time calculation unit 101 then calculates a value obtained by dividing the total of the result times Th indicated in the read result data 6F by the total of the numbers of pages indicated in the read result data 6F as the unit required time Tm. For example, when the total of the result times Tb is Ts1 and the total of the numbers of pages is S, Ts1/S is calculated as the unit required time Tm.

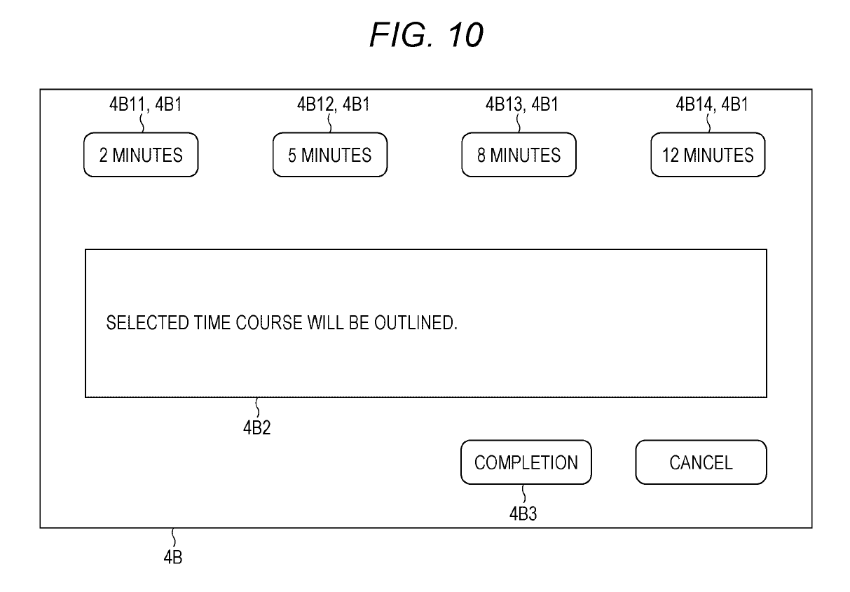

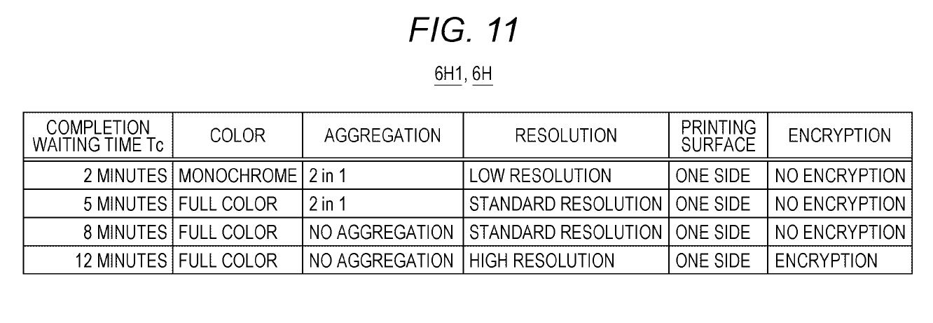

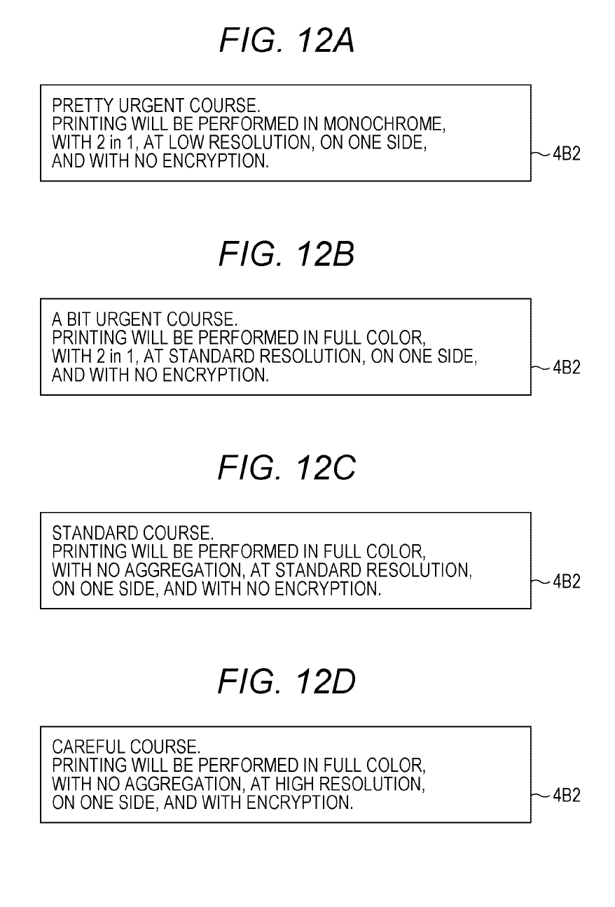

FIG. 10 illustrates an example of a condition selection screen 4B. FIG. 11 illustrates an example of response data 6H1. FIGS. 12A to 12D illustrate examples of messages displayed in a message area 4B2.

By the way, when using the condition presenting function, the user is required to click a time designation button 4A6 of the condition input screen 4A (see FIG. 6). Each unit of the image forming apparatus 1 and each unit of the terminal device 2 then perform processing as follows.

When the time designation button 4A6 is clicked, the completion waiting time inquiry unit 203 inquires of the image forming apparatus 1 the time to be taken for finishing printing of the document 5 to be printed by transmitting inquiry data 6G to the image forming apparatus 1 in the terminal device 2. The number of pages of the document 5 is indicated in the inquiry data 6G. An example in which a time to be taken for finishing printing of the document 51 illustrated in FIG. 5 is inquired will now be described.

Upon receiving the inquiry data 6G, the completion waiting time calculation unit 107 calculates a time predicted to be taken for finishing execution of a PC print job of the document 51 in a printing condition group for each printing condition group in the image forming apparatus 1. This time will hereinafter be referred to as a “completion waiting time Tc”.

As illustrated in FIG. 7, 24 sets of printing condition groups exist in the present embodiment. The completion waiting time calculation unit 107 thus calculates the completion waiting time Tc for each of the 24 sets of printing condition groups.

The completion waiting time calculation unit 107 calculates the completion waiting time Tc for each of the printing condition groups from, for example, the following expression (1).

Tck=Td×F1+Tmk×Ca+Tp+Tq (1)

“Tck” is the completion waiting time Tc for the k-th set of printing condition group. “Td” is the time required to warm up the print unit 10j. “F1” is a variable indicating whether or not the time Td is needed. When the print unit 10j has already been warmed up now, “0” is assigned to “F1”, and when the print unit 10j has not yet been warmed up. “1” is assigned. Necessity of the warm-up is required to be inquired to the operating system or the print unit 10j. The time Td is required to be preliminarily determined by experimentally performing the warm-up and measuring the time taken for the warm-up. The value of the time Td may be changed according to room temperatures.

“Tmk” is the unit required time Tm for the k-th set. The unit required time Tm may be read from the unit required time table 6D, or may be calculated based on the result data 6F stored in the result data storage unit 106 as described above. “Ca” is the number of pages indicated in the inquiry data 6G.

“Tp” is the total of the required times Ta for execution-waiting jobs in a printing phase. Each of the required times Ta is indicated in the job data 6E for each job stored in the job data storage unit 103.

“Tq” is a time taken for finishing a job being executed in the printing phase. The time Tq is calculated by subtracting an elapsed time Tr from the start of the printing phase of the job to the current time from the required time Ta indicated in the job data 6E of the job.

For example, when a warm-up is needed. “3” is indicated in the inquiry data 6G as the number of pages, two jobs being executed in the printing phase exist, the required times Ta for the jobs are required times Ta2 and Ta3, the required time Ta for a job being executed is Ta1, and the elapsed time Tr is an elapsed time Tr1, the completion waiting time calculation unit 107 calculates Tc10=Td×1+Tm10×3+(Ta2+Ta3)+(Ta1−Tr1) as the completion waiting time Tc for a combination of “monochrome”, “low resolution”, “2 in 1”, and “both sides”, that is, the tenth printing condition group.

By the way, a time taken from the start of generation of the print data 6B at the terminal device 2 to the reception of the print data 6B at the image forming apparatus 1 is desirably considered in the completion waiting time Tc. In addition, the time differs between when the print data 6B is encrypted and exchanged and when exchanged without being encrypted.

The completion waiting time calculation unit 107 may thus calculate completion waiting times Tf and Tg as the completion waiting time Tc from the following expressions (2) and (3).

Ttk=Td×F1+Tmk×Ca+Tp+Tq+Th×Ca (2)

Tgk=Td×F1+Tmk×Ca+Tp+Tq+Ti×Ca (3)

“Ttk” is the completion waiting time Tf for the k-th set of printing condition group. “Tgk” is the completion waiting time Tg for the k-th set of printing condition group.

“Th” is a time per page for the document 5, taken from the start of generation of the print data 6B at the terminal device 2 to the reception of the print data 6B at the image forming apparatus 1. This is, however, the time taken when the print data 6B is transmitted from the terminal device 2 to the image forming apparatus 1 without being encrypted.

“Ti” is a time per page for the document 5. In the time, the terminal device 2 starts generating the print data 6B, the print data 6B is encrypted and exchanged between the terminal device 2 and the image forming apparatus 1, and the print data 6B is decrypted at the image forming apparatus 1.

The time Th and the time Ti are required to be preliminarily determined by experimentally, for example, generating, transmitting, and receiving the print data 6B and the condition data 6C.

An example in which the completion waiting time calculation unit 107 calculates the completion waiting time Tc from the expressions (2) and (3) will now be described.

According to the example, the completion waiting time Tc for each of cases with and without encryption is calculated for each of the 24 sets of printing condition groups as a result of processing with the completion waiting time calculation unit 107. In other words, one completion waiting time Tc is calculated for each combination of the printing condition group and the encryption condition. The combination of the printing condition group and the encryption condition will hereinafter be referred to as a “job condition group”. In the example, 24 sets of printing condition groups and two encryption conditions exist, and therefore 24×2, that is, 48 sets of job condition groups exist.

The response data transmission unit 108 transmits the response data 6H to the terminal device 2. A content (constituent conditions) and the completion waiting time Tc of each job condition group are indicated in the response data 6H.

By the way, according to the example, the content and the completion waiting time Tc are indicated in the response data 6H for each of the 48 sets of job condition groups. These pieces of information are used for the user to select a condition for printing the document 5. Unfortunately, when a lot of sets of job condition groups exist, the user has difficulty in finding a desired condition.

The completion waiting time calculation unit 107 then may select a predetermined number of sets of job condition groups from the 48 sets of job condition groups, and generate the response data 6H such that the content and the completion waiting time Tc is indicated only for the selected job condition groups. The job condition group is required to be preferentially selected from those often designated as a printing condition in the past. Alternatively, a job condition group to be selected may be preset for each user. A job condition group suitable for the user who operates the terminal device 2 is then required to be selected.

When the response data 6H is received, the second printing condition receiving unit 204 displays the condition selection screen 4B on the touch panel display 20e instead of the condition input screen 4A in the terminal device 2.

As illustrated in FIG. 10, a selection button 4B1 for each job condition group, whose content and completion waiting time Tc are indicated in the response data 6H, is arranged on the condition selection screen 4B. The completion waiting time Tc for the job condition group corresponding to each selection button 4B1 is indicated in each selection button 4B1 as a button name.

For example, when the response data 6H1 as illustrated in FIG. 11 is received as the response data 6H, selection buttons 4B11, 4B12, 4B13, and 4B14, which respectively have button names “2 minutes”, “5 minutes”, “8 minutes”, and “12 minutes”, are arranged as the selection buttons 4B1.

The user can focus on one of the selection buttons 4B1 by hovering a mouse pointer.

When the mouse pointer is hovered over one of the selection buttons 4B1, the second printing condition receiving unit 204 presents the content of the job condition group corresponding to the selection button 4B1 indicated in the response data 6H in the message area 4B2.

For example, when the response data 6H1 is received as the response data 6H, the second printing condition receiving unit 204 presents the content of the job condition group in the message area 4B2 as illustrated in FIGS. 12A to 12D at the time when the mouse pointer is hovered over each of the selection buttons 4B11 to 4B14. Note that each of messages “pretty urgent course”, “a bit urgent course”, “standard course”, and “careful course” in the first line is placed according to the completion waiting time Tc. For example, when the completion waiting time Tc is less than three minutes, the message “pretty urgent course” is placed. When the completion waiting time Tc is three minutes or more and less than six minutes, the message “a bit urgent course” is placed. When the completion waiting time Tc is six minutes or more and less than ten minutes, the message “standard course” is placed. When the completion waiting time Tc is ten minutes or more, the message “careful course” is placed.

The user matches the mouse pointer to one of the selection buttons 4B1 to confirm the content of the job condition group as necessary. The user determines a job condition group preferable as a condition for printing the document 5. The user may determine the job condition group by referring by referring only to the completion waiting time Tc represented by the button name, only to the content indicated by the message area 4B2, or to both. The user then clicks the selection button 4B1 corresponding to the determined job condition group, and clicks a completion button 4B3.

The print job execution instruction unit 202 then generates print data for printing the document 5 according to the job condition group corresponding to the clicked selection button 4B1 in the PDL of the image forming apparatus 1, and transmits the print data to the image forming apparatus 1 as the print data 6B. At this time, the print job execution instruction unit 202 transmits data indicating the content of the job condition group and the number of pages of the document 5 to the image forming apparatus 1 as the condition data 6C. Note that, when the job condition group contains a condition to perform encryption, the print job execution instruction unit 202 encrypts and transmits the print data 6B and the condition data 6C.

For example, when the selection button 4B 14 is clicked, and then the completion button 4B3 is clicked, the print job execution instruction unit 202 generates data for printing the document 5 without aggregating pages, on one side of paper, in full color, and at high resolution, as the print data 6B. The print job execution instruction unit 202 then encrypts the print data 6B and the condition data 6C, and transmits these pieces of data to the image forming apparatus 1.

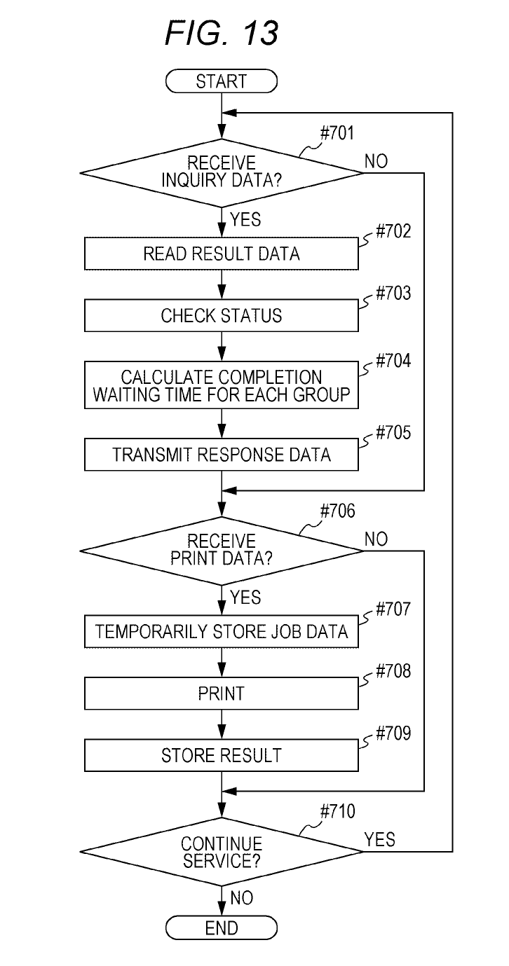

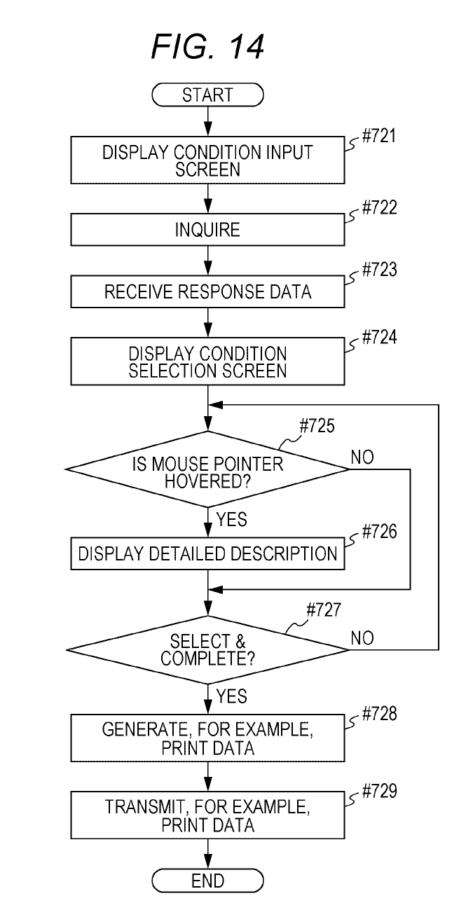

FIG. 13 is a flowchart illustrating an example of the overall processing flow of the image forming apparatus 1. FIG. 14 is a flowchart illustrating an example of the overall processing flow of the terminal device 2.

An example of the overall processing flow of each of the image forming apparatus 1 and the terminal device 2 will now be described with reference to the flowcharts with an example of a case of printing the document 51 illustrated in FIG. 5.

The image forming apparatus 1 executes processing in the procedure illustrated in FIG. 13 based on the print job program 10P. On the other hand, the terminal device 2 executes processing in the procedure illustrated in FIG. 14 based on the printer driver 20P.

The user opens the file 6A of the document 51 with an application of the terminal device 2, and inputs a printing command.

The terminal device 2 then displays the condition input screen 4A (see FIG. 6) (#721 in FIG. 14). When the time designation button 4A6 is clicked, the terminal device 2 inquires of the image forming apparatus 1 the time to be taken for finishing printing of the document 51 by transmitting the inquiry data 6G to the image forming apparatus 1 (#722).

Upon receiving the inquiry data 6G (Yes in #701 of FIG. 13), the image forming apparatus 1 reads the unit required time table 6D (see FIG. 7) or the result data 6F (see FIG. 9) (#702), checks whether or not the print unit 10j has been warmed up (#703), and calculates the completion waiting time Tc for each job condition group (#704). The image forming apparatus 1 then transmits data indicating, for example, the completion waiting time Tc to the terminal device 2 as the response data 6H (see FIG. 11) (#705).

Upon receiving the response data 6H (#723), the terminal device 2 displays the condition selection screen 4B (see FIG. 10) instead of the condition input screen 4A (#724). Each time a mouse pointer is hovered over one of the selection buttons 4B1 (Yes in #725), the terminal device 2 then presents the content of the job condition group, corresponding to the selection button 4B1 over which the mouse pointer is hovered, illustrated in the response data 6H in the message area 4B2 (#726).

When one of the selection buttons 4B1 is clicked, and then the completion button 4B3 is clicked (Yes in #727), the terminal device 2 generates the print data 6B and the condition data 6C based on the job condition group corresponding to the clicked selection button 4B1, and transmits these pieces of data to the image forming apparatus 1 (#728, #729).

Upon receiving the print data 6B and the condition data 6C (#706), the image forming apparatus 1 generates the job data 6E (see FIG. 8) of the document 51, and temporarily stores the job data 6E with the job data storage unit 103 until the document 51 is printed (#707). When the turn of the document 51 comes, the image forming apparatus 1 then prints the document 51 on paper based on the print data 6B (#708), and stores the result data 6F of the document 51 with the result data storage unit 106 (#709).

According to the embodiment, even when the user is in a hurry, printed matters can be provided in a state desired by the user more reliably than before. Moreover, when there is time to spare, printed matters of quality according to the time can be generated.

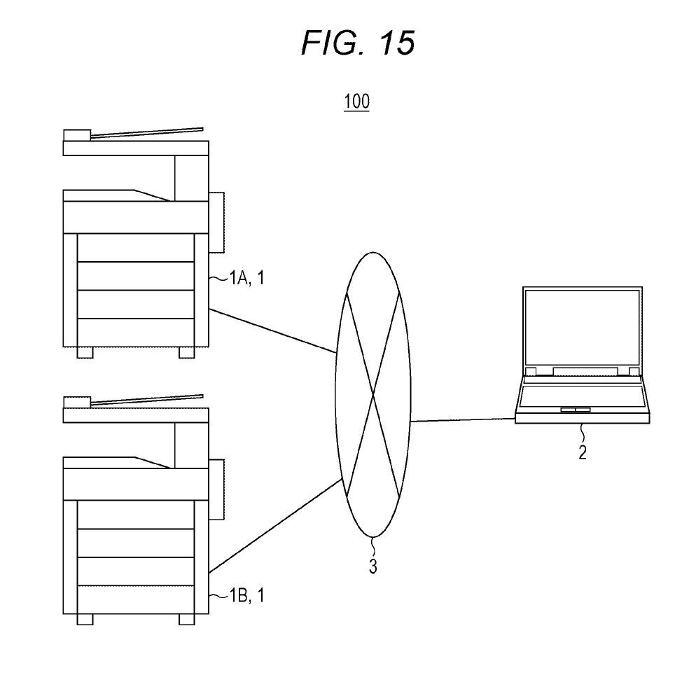

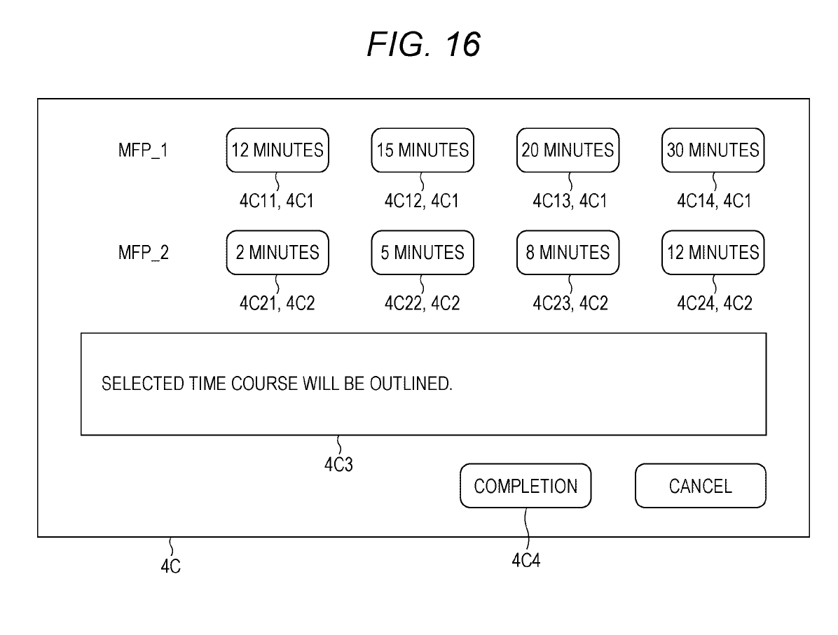

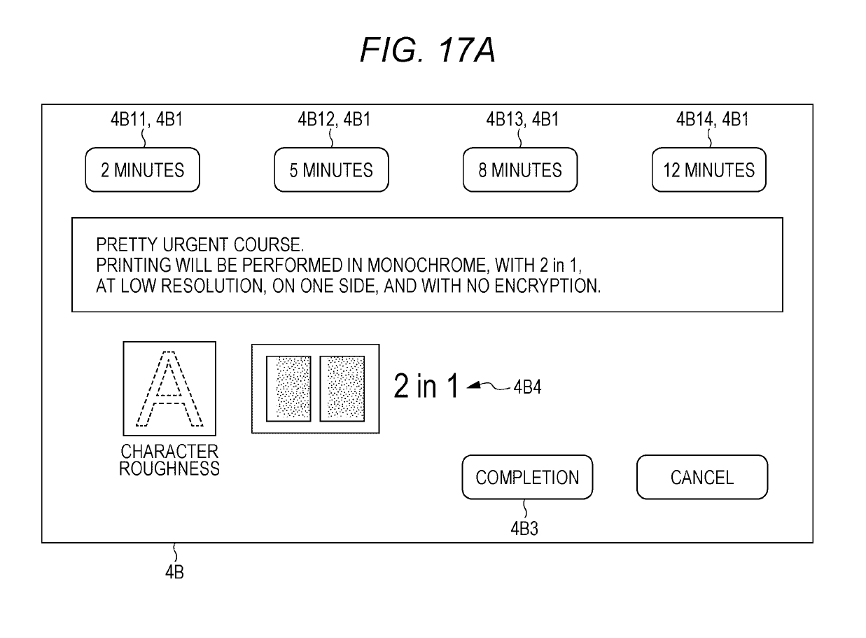

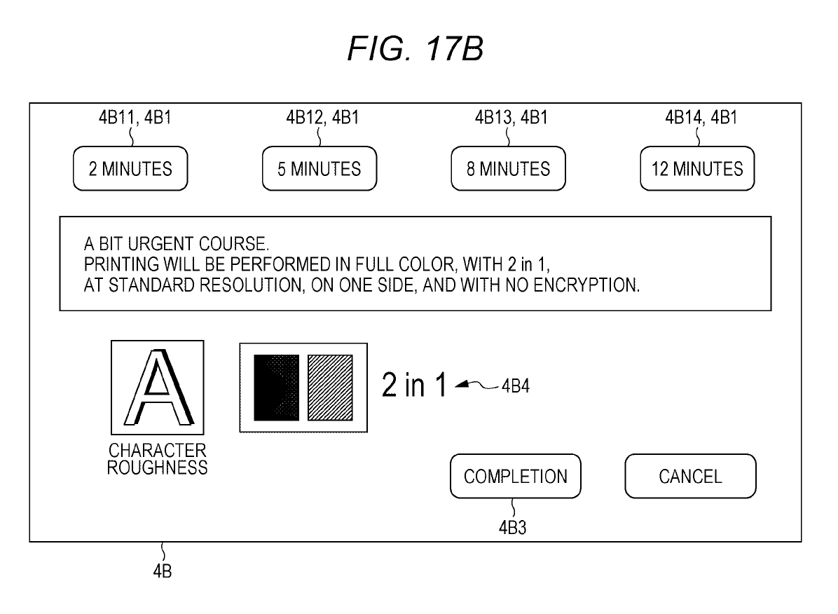

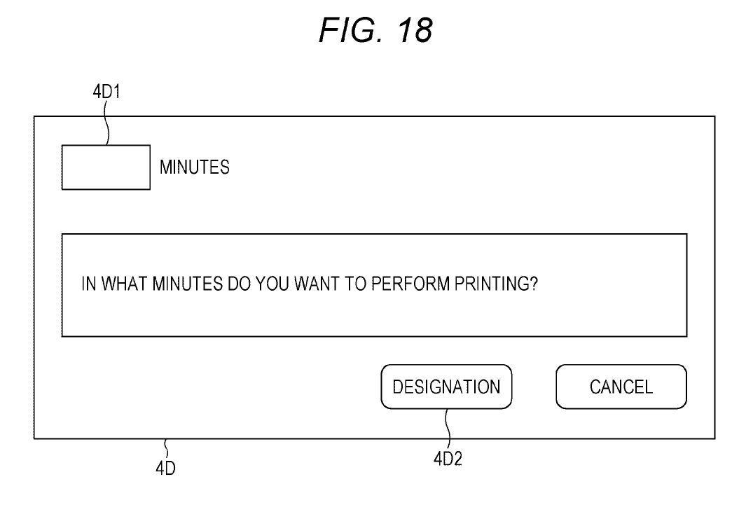

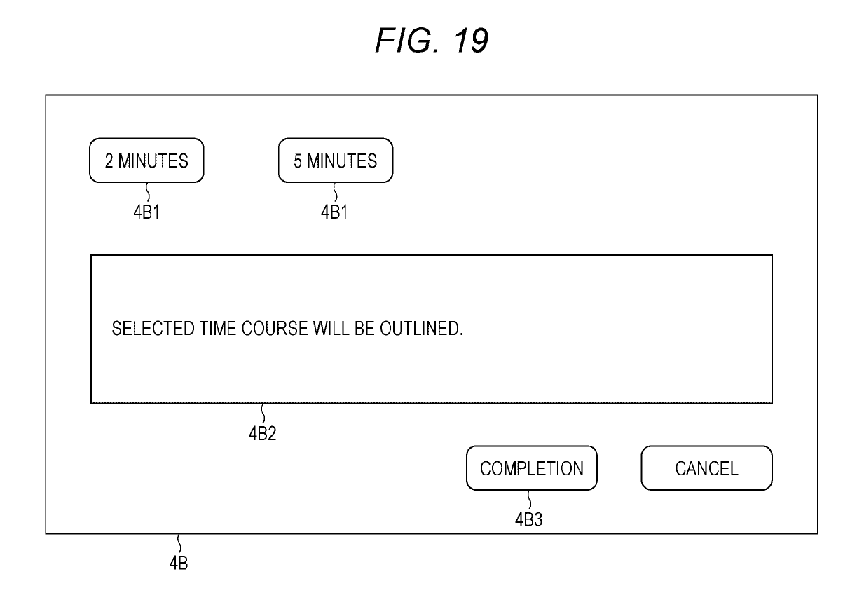

FIG. 15 illustrates a variation of the overall configuration of the image forming apparatus 1. FIG. 16 illustrates an example of a condition selection screen 4C. FIGS. 17A and 17B illustrate variations of the condition selection screen 4B. FIG. 18 illustrates an example of a threshold designation screen 4D. FIG. 19 illustrates a variation of the condition selection screen 4B.

Although, in the embodiment, the image forming apparatus 1 calculates the completion waiting time Tc for printing the document 5 by the PC print function, the image forming apparatus 1 can calculate the completion waiting time Tc for printing the document 5 by another function.

For example, the image forming apparatus 1 can calculate the completion waiting time Tc for printing the document 5 by the function of printing the image read by the scan unit 10i, that is, the copying function.

In this case, however, the image forming apparatus 1 is required to measure the thickness of a bundle of pieces of paper of the document 5 set in an auto document feeder (ADF) of the scan unit 10i with a thickness detector, and calculate the number of pages based on the measured thickness and the thickness per paper. The image forming apparatus 1 then calculates the required time Ta (see FIG. 8) by using the calculated number of pages instead of the number of pages indicated in the condition data 6C, and using the condition of each of the four items input in the touch panel display 10e instead of the printing condition group indicated in the condition data 6C. In addition, the image forming apparatus 1 calculates the completion waiting time Tck by using the expression (1) instead of the expressions (2) and (3), and using the calculated number of pages instead of the number of pages Ca in the expression (1). A screen corresponding to the condition selection screen 4B (see FIG. 10) is displayed by the touch panel display 10e.

In the case of printing by the copying function, a condition of a reading resolution may be added in addition to the condition for each of the above-described four items (printing resolution, printing surface, color and aggregation). The image forming apparatus 1 may thus calculate the completion waiting time Tck defining the combination of the conditions of these five items as the printing condition group. In this case, if the reading speed of the scan unit 10i is slower than the printing speed of the print unit 10j, the image forming apparatus 1 may also calculate the completion waiting time Tck by an expression that uses a reading speed as a parameter in addition to each parameter indicated in the expression (1).

Alternatively, the image forming apparatus 1 can calculate the completion waiting time Tc for printing the document 5 by the function of printing an image whose image data is stored in a box, that is, a box printing function.

In this case, however, the image forming apparatus 1 calculates the completion waiting time Tck by the expression (1) instead of the expressions (2) and (3). Note that, when the image data is not written in a PDL, the time for conversion to the PDL may be added to the right side of the expression (1). A screen corresponding to the condition selection screen 4B is displayed by the touch panel display 10e.

In the embodiment, the terminal device 2 inquires of only a single image forming apparatus 1 the completion waiting time Tc. When a plurality of image forming apparatuses 1 is provided in the printing system 100 as illustrated in FIG. 15, however, the terminal device 2 may inquire of the plurality of image forming apparatuses 1. In this case, a program for inquiry may be installed in the terminal device 2, and the terminal device 2 may inquire of each image forming apparatus 1 by using the program.

For example, when inquiring of image forming apparatuses 1A and 1B, the terminal device 2 is required to display the condition selection screen 4C indicating each completion waiting time Tc as illustrated in FIG. 16 based on the response data 6H received from each of the image forming apparatuses 1A and 1B. When the mouse pointer is hovered over one of the selection buttons 4C11 to 4C14, the terminal device 2 displays the content of the job condition group, corresponding to a selection button 4C1 over which the mouse pointer is hovered, in a message area 4C3 based on the response data 6H obtained from the image forming apparatus 1A. Similarly, when the mouse pointer is hovered over one of selection buttons 4C21 to 4C24, the terminal device 2 displays the content of the job condition group, corresponding to a selection button 4C2 over which the mouse pointer is hovered, in the message area 4C3 based on the response data 6H obtained from the image forming apparatus 1B.

When one of the selection buttons 4C11 to 4C14 is clicked, and then a completion button 4C4 is clicked, the terminal device 2 then generates the print data 6B and the condition data 6C based on the job condition group corresponding to the clicked selection button 4C1, and transmits these pieces of data to the image forming apparatus 1A. Similarly, when one of the selection buttons 4C21 to 4C24 is clicked, and then a completion button 4C4 is clicked, the terminal device 2 generates the print data 6B and the condition data 6C based on the job condition group corresponding to the clicked selection button 4C2, and transmits these pieces of data to the image forming apparatus 1B.

Although, in the embodiment, when the mouse pointer is hovered over one of the selection buttons 4B1, the terminal device 2 displays, for example, the content of the job condition group corresponding to the selection button 4B1 in the message area 4B2, the terminal device 2 may also display an illustration (so-called pseudo preview image) expressing each condition of the job condition group as illustrated in FIG. 17A or 17B.

Although, in the embodiment, when inquiring the completion waiting time Tc, the user only clicks the time designation button 4A6, the completion waiting time inquiry unit 203 may be configured to be able to designate minutes within which the user desires to complete printing of the document 5.

Specifically, when the time designation button 4A6 is clicked, the completion waiting time inquiry unit 203 displays the threshold designation screen 4D as illustrated in FIG. 18 on the touch panel display 20e. The user inputs a desired time until completion of printing in a text box 4D1, and clicks a designation button 4D2.

The completion waiting time inquiry unit 203 then transmits data indicating not only the number of pages of the document 5 but the time input in the text box 4D1 to the image forming apparatus 1 as the inquiry data 6G.

In the image forming apparatus 1, the response data transmission unit 108 selects a job condition group whose completion waiting time Tc is within the time indicated in the inquiry data 6G from the job condition groups whose completion waiting times Tc are calculated by the completion waiting time calculation unit 107. The response data transmission unit 108 then transmits the data indicating the content and the completion waiting time Tc of each of the selected job condition groups to the terminal device 2 as the response data 6H.

In the terminal device 2, the second printing condition receiving unit 204 displays the condition selection screen 4B based on the response data 6H. As a result, for example, when “6” is input in the text box 4D1, the condition selection screen 4B is displayed as illustrated in FIG. 19. Note that, when a time is not designated, the condition selection screen 4B is displayed as illustrated in FIG. 10.

Although, in the embodiment, the completion waiting time Tc is presented by the condition selection screen 4B, a time in which other jobs are not considered, that is, Td×F1+Tmk×Ca may be presented instead of the completion waiting time Tc.

Although, in the embodiment, the selection button 4B1 is focused by hovering the mouse pointer, the selection button 4B1 may be focused by tapping with a finger.

Although, in the embodiment, the image forming apparatus 1 calculates the completion waiting time Tc, the terminal device 2 may calculate the completion waiting time Tc. In this case, the terminal device 2 may download data necessary for calculating the completion waiting time Tc from the image forming apparatus 1. Alternatively, a server may be provided in the printing system 100, and the completion waiting time Tc may be calculated by the server.

In addition, for example, the configuration of the whole or each part of the printing system 100, the image forming apparatus 1, and the terminal device 2, the combination of the printing conditions, a method of calculating the required time Ta, a method of calculating the completion waiting time Tc, a processing content, a processing order, a screen configuration, and a data configuration can be appropriately changed according to the spirit of the invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. A printing system comprising:
a printer; and
a terminal device,
wherein an inquirer that inquires of the printer a predicted time to be taken for printing a document to be printed is provided in the terminal device,
a calculator that calculates a predicted time to be taken for the printer to print the document under each of a plurality of conditions and
a responder that responds to the terminal device about the predicted time for each of the plurality of conditions are provided in the printer,
a presenter that displays the plurality of conditions and the predicted time for each of the plurality of conditions on a display and
an instructor that instructs the printer to print the document under a condition selected from the plurality of conditions are also provided in the terminal device, and
a printing part that prints the document under the condition selected from the plurality of conditions is also provided in the printer.

2. The printing system according to claim 1,
wherein the presenter displays each of the plurality of conditions as a character string representing each of the plurality of conditions.

3. The printing system according to claim 1,
wherein the presenter displays each of the plurality of conditions as an illustration representing each of the plurality of conditions.

4. The printing system according to claim 1,
wherein the presenter displays the predicted time for each of the plurality of conditions as an option for selecting each of the plurality of conditions.

5. The printing system according to claim 4,
wherein, when one of the predicted times displayed on the display is focused on, the presenter displays a condition corresponding to the focused predicted time from the plurality of conditions.

6. The printing system according to claim 1,
wherein the calculator calculates a time for finishing printing of the document under a current condition of the printer as the predicted time.

7. The printing system according to claim 1,
wherein each of the plurality of conditions is a group obtained by combining conditions of a plurality of items.

8. The printing system according to claim 1,
wherein the presenter displays only a predicted time that satisfies a requirement designated by a user from the predicted times for the plurality of conditions.

9. The printing system according to claim 1, comprising a plurality of the printers,
wherein the inquirer inquires of each of the plurality of printers the predicted time,
the presenter displays the plurality of conditions about which each of the plurality of printers has responded and the predicted time for each of the plurality of conditions, on a display,
the instructor gives an instruction to print the document under a condition selected from the plurality of conditions of each of the plurality of printers to a printer that has responded about the selected condition of the plurality of printers.

10. An information processor comprising:
an acquirer that acquires a predicted time to be taken for printing a document to be printed with a printer under each of a plurality of conditions; and
a notifier that gives notice of the plurality of conditions and the predicted time for each of the plurality of conditions.

11. The information processor according to claim 10, further comprising a printing part that prints the document under a condition selected from the plurality of conditions.

12. The information processor according to claim 11,
wherein the notifier notifies a terminal device of the plurality of conditions and the predicted time for each of the plurality of conditions.

13. The information processor according to claim 12,
wherein the printing part prints the document under a condition selected from the plurality of conditions at the terminal device.

14. The information processor according to claim 11,
wherein the notifier gives notice of the plurality of conditions and the predicted time for each of the plurality of conditions by displaying the plurality of conditions and the predicted time for each of the plurality of conditions on a display.

15. The information processor according to claim 14,
wherein the printing part prints the document under a condition selected from the plurality of conditions displayed on the display.

16. The information processor according to claim 10, further comprising a print controller that causes the printer to print the document under a condition selected from the plurality of conditions,
wherein the acquirer calculates the predicted time based on information acquired from the printer.

17. The information processor according to claim 10,
wherein the acquirer acquires the predicted time by inquiring of the printer the predicted time, and
the notifier gives notice of the predicted time by displaying the predicted time on a display.

18. The information processor according to claim 17, further comprising a print controller that causes the printer to print the document under a condition selected from the plurality of conditions displayed on the display.

19. A terminal device comprising:
an inquirer that inquires of a printer a predicted time to be taken for printing a document to be printed with the printer;
a presenter that displays a plurality of conditions and the predicted time for each of the plurality of conditions about which the printer has responded, on a display; and
a print controller that causes the printer to print the document under a condition selected from the plurality of conditions.
